(19) United States
(12) Patent Application Publication
(10) Pub. No.: US 2002/0157014 A1
(43) Pub. Date: Oct. 24, 2002

(54) Privacy control system for personal information card system and method thereof

(75) Inventor: Hongyi Zhou, Beijing (CN)

Correspondence Address: Jie Sha, 195 North Harbor Drive, Suite 3504, Chicago, IL, 60601, US

(73) Assignee: Inter China Network Software Company Limited

(21) Appl. No.: 09/837,497

(22) Filed: Apr. 18, 2001

(51) Int. Cl. H04L 9/32

(52) U.S. Cl. 713/200

(57) ABSTRACT

In a personal information web card system including a server having a database and a search engine, a privacy control system comprises means for storing a set of web card information of each individual user of the web card system; means for determining privacy control levels of the web card information of the individual user as selected by the individual user; means for transmitting, at the registration user's initiation, selected web card information of a particular privacy control level with an authorization code to other users; means for storing a table of authorized names of the other users for each level of privacy control; means for looking through the table of authorized users' names when any of the other users conducts a search; means for generating a corresponding web card of the individual user to the other user once the authorization is confirmed.

### FIELD OF THE INVENTION

The present invention relates to a system and method of online personal information management, more particularly to a system and method of privacy control and protection of personal information web cards.

### BACKGROUND OF THE INVENTION:

Up to now, most all of electronic personal information management (PIM) systems are localized personal information management systems, in which individuals or users of the systems enter the personal data of their own and of their friends or contacts. Such systems are provided in individual electronic apparatus, such as personal computers, palm top computers, or any other kinds of electronic organizers, most using Microsoft Outlook, Lotus, or other address books. However, some of those electronic apparatus may not be easily carried around, some may not be kept handy, and some may not be updated often although certain synchronization software are available. Thus, it indeed causes inconsistency of data stored in various personal electronic apparatus a person may have.

Therefore, several web-based personal information management systems have been established to provide the remote storage and database of personal information, that are accessible through the Internet, such as addresses, calendars, and contacts. Such systems are, for instance, www.ecode.com, www.planetall.com, and www.backup.com. The eCode provides the personal information in electronic card format. Further, there are many existing online telephone directory services in various formats, such as “yellow pages” or “white pages.” With the establishment of remote storage and databases of personal information management, the accompanying technology of accessing such databases has been gradually developed. For instance, the Contact Networks, Inc. has several pending patent applications, e.g., WO 00/67105, WO 00/67106, WO 00/67108, WO 00/67416.

WO 00/67105 discloses a method and apparatus for publishing and synchronizing selected user information over a network. It describes a kind of virtual personal information cards that may be communicated to various receiving users under the control of the publishing user. When the publishing user changes the personal information, such changes will be propagated to all holders of the publishing user's card. WO 00/67416 discloses the automatic updates of the personal information and synchronization of the updates to all receiving users. The system and method of Contact Networks, Inc., however, has not resolved the problem of the aforesaid traditional search problem, that is, requiring “exact or complete” match of the search word with the entry or entries of the database. Nor it resolves the globalization of network of systems of web card information. Although some aspect of privacy control is mentioned in WO/67416, it dose not teach how the privacy issue of the web cards can be more efficiently executed, and how such a system can be adopted for various users of different languages.

In almost all of such remote PIM database systems, each entry of such names, telephones, and sometimes addresses can be searched using exact matching words, such as names and telephone numbers, etc. If the entered inquiry cannot exactly match the entry of information, several closest possible entries may be provided for selection. However, quite often the search may end up with a result of “no matching entry.” Thus, the searcher may have to modify the inquiry again and again. Finally, the searcher might give up because of frustration of repeatedly modification of inquiries when no result can be generated through several attempts. This is because most of the time the searcher lacks accurate description of the person being searched, for instance, lacking of correct spelling of the words or exact matching characters to get the correct result, not just some phonetic equivalent words or characters. The problem for such search is the requirement of completely or exact “matching” of the search words with the words of entry or entries. No matching, no result.

In case of searching somebody with whom you do not have any contact for quite a while or someone you just ran into once or twice, you probably do not have much information about him or her. You could hardly remember his or her name. Or sometimes, you lost your collection of business cards or databank or simply you do not have such information handy. Nonetheless, you do know something about him or her, such as where he or she studied, lived or worked before, his or her nickname, or what his or her hobby was, etc. In any event, you do have a desire or necessity to find him or her for whatever reason is, but do not have accurate contact information. Using the aforesaid traditional search method, you will probably get nothing, or will have to try tens or hundreds of times before you finally get the information you want. In the real life, no-body would like to try many times to get a simple search result. Therefore, how we could intelligently find someone's information without too much trouble has become a problem waiting to be solved.

Nowadays, Internet accessible electronic information management apparatus are widely used and becoming more and more popular, such as mobile phones, pagers, notebook computers, palm top computers, or any kinds of personal computers or data apparatus. You may find such an access to such instruments anywhere, such as offices, schools, homes, stores, libraries, or other public facilities. If you are traveling or just away from your own home or office where you usually keep your personal information files or cards, you might think of using the Internet to get what you want. If there were a reliable service on the Internet providing a readily available and accurately accessible database for all of individuals, anyone could then get the contact information of someone wanted from anywhere.

Accordingly it is an object of the present invention to provide a privacy control system for any search done through the system of personal information web cards, through which any Internet user may obtain a piece of desired information of someone based on a minimum description of that person, but may be subject to the privacy control as set up by that person.

It is another object of the present invention to provide an information web card system, that contains all necessary information of individuals to assist the search, but any private and intimate personal information will not necessarily be disclosed.

### SUMMARY OF THE INVENTION:

The present invention relates to a privacy control system for personal and business web cards system including at least a server having at least a database and a search engine. The privacy control system comprises means for storing a set of web card information of each individual user of the web card system; means for determining privacy control levels of the web card information of the individual user as selected by the individual user; means for transmitting, at the registration user's initiation, selected web card information of a particular privacy control level with an authorization code to other users; means for storing a table of authorized names of the other users for each level of privacy control; means for looking through the table of authorized users' names when any of the other users conducts a search; means for generating a corresponding web card of the individual user to the other user once the authorization is confirmed.

The server is equipped with the aforesaid control means and the web card information is stored in the database of the server. The search engine of the server receives the search inquiry of the other users, and performs the search and issuance of the corresponding cards. The privacy control levels of the personal web card information are divided normally into three levels corresponding to three versions of web cards, that is, simplified version, regular version, and detailed version. The authorized users or selected groups of users are predetermined and set up by the particular web card user or owner.

The present invention can be better understood through the following detailed description in connection with the accompanying illustrative figures.

### BRIEF DESCRIPTION OF THE DRAWINGS:

FIG. 1A is illustrative of the system of the present invention;

FIG. 1B illustrates a network system of the web card according to the present invention;

FIG. 2A-C show the appearance of the interactive screen of the present invention;

FIG. 3A shows a conventional arrangement of the data structure for the exact matching search;

FIG. 3B shows an arrangement of the data structure of the present invention;

FIG. 4A is a flow chart of the conventional exact matching search;

FIG. 4B is a flow chart illustrative of the fuzzy search of the personal and business web cards according to the present invention;

FIG. 5 is a diagram showing that a set of personal information web cards is divided into three versions corresponding to three privacy control levels, for receipt and search of such web cards by the other users; and

FIG. 6A and FIG. 6B are flow charts of the method of the present invention, respectively illustrative of how a personal web card is being dispatched through the Internet to other selected users, and how other users may search the web card information and get a corresponding web card under the privacy control.

### DETAILED DESCRIPTION OF THE INVENTION:

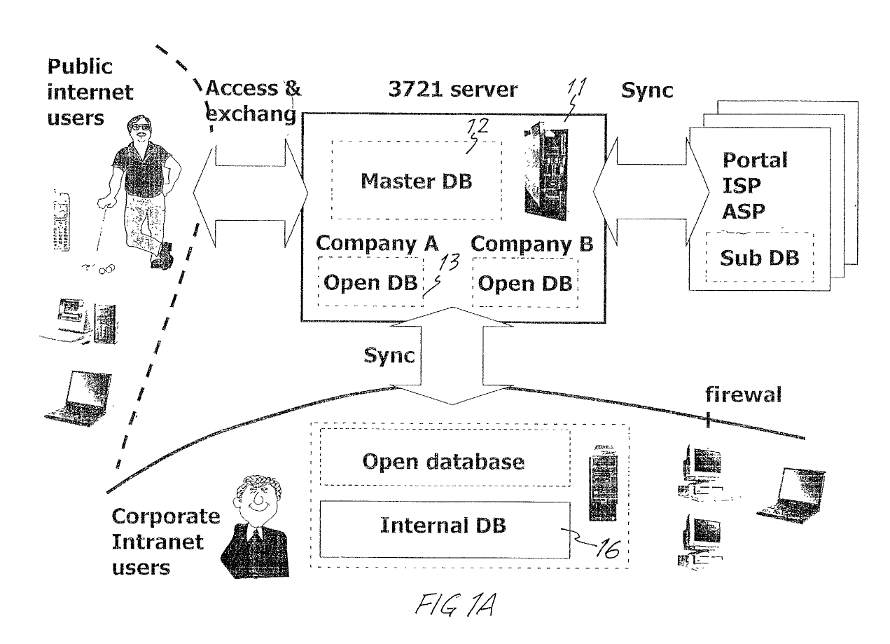

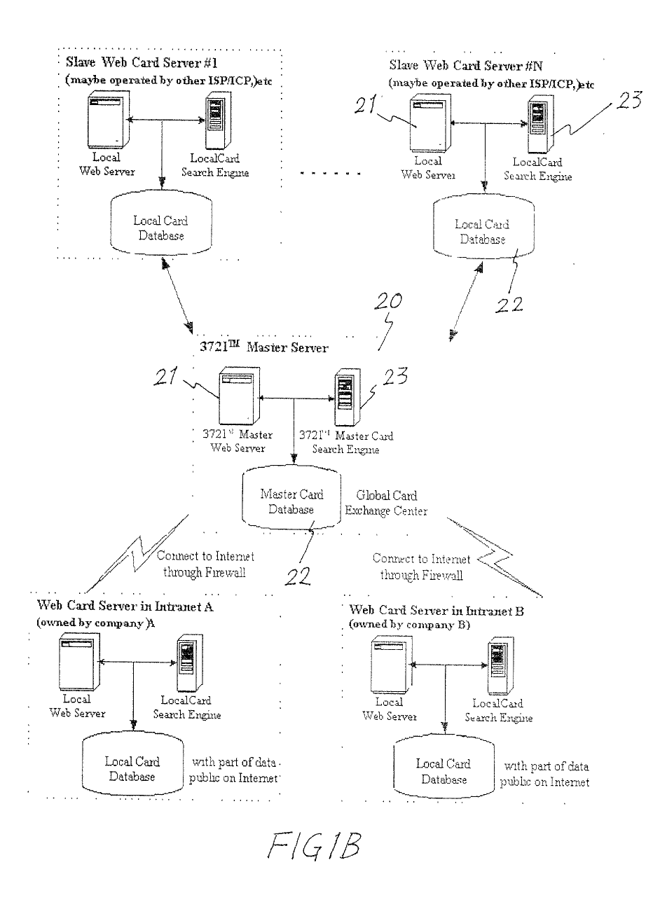

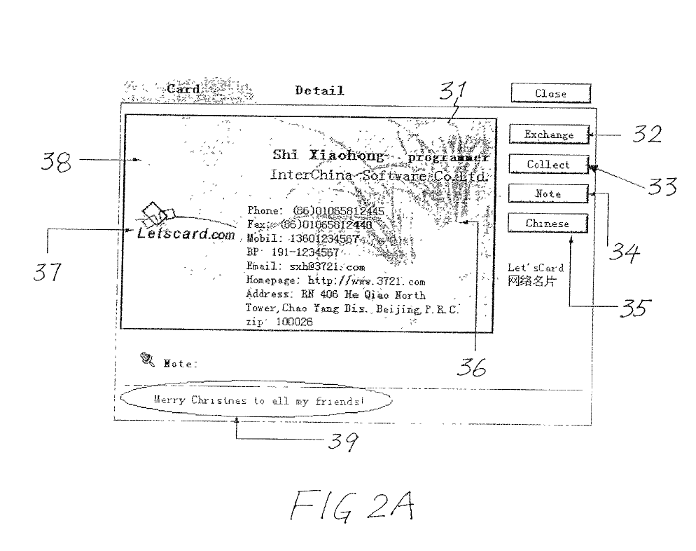

With reference to FIG. 1A, a server 11, as marked 3721™ server, contains a master database 12, and sub-databases 13, such as company A and company B's databases. The various electronic equipment are the public Internet users' tools to access the Internet and then search the 3721™ server 11, such as lap top computers, personal computers, cell phones, and other data apparatus. No matter where they are located, they may conduct a search at the 3721™ server when they log on the Internet. FIG. 1 shows that the public individual users are linked directly to the 3721™ server 11. However, the individual users may also be linked to a portal ISP 14 or ASP 15, and in turn the ISP 14 or ASP 15 is in connection with the 3721™ server 11. The ISP 14 or ASP 15 contains its own database that may include their own personal or business information or telephone directories.

Further, as seen in FIG. 1A, the various electronic equipment may also be an intranet of a company, which contains an internal database of its own. Such an intranet database is normally used for intranet users only. When the intranet users need to search others' information, they may need to access the Internet or outside databases, such as the 3721™ server 11. On the other hand, the personal or business information of others may also be stored therein for use by the intranet users. Such personal or business information of others or publicly known information of the company needs to be updated from time to time. In this situation, a firewall is necessary to protect the confidential information in the intranet database.

FIG. 1B illustrates the networking of the personal and business web card system of the present invention. Each block illustrates a web card server or a system unit. Each of such system or unit includes its own card database and card search engine. In consideration of the performance and load balance, each system may comprise one or more physical servers, for instance, one for the master or local web server 16, one for the master or local search engine, and one or more for the master or local database. A service vendor (ISP/ICP, etc.) may operate a web card unit independently, while the most important is that these web card units, although independent, can communicate with each other through specific built-in interfaces. Hence, such connected and communicated web card systems or units construct a global distributed web card system. Within such a global system 20, a user may search anyone's web card regardless with which vendor the desired person's web card is registered. Certainly, the users can communicate with each other through their web cards, such as, writing emails, notes, or exchanging web cards.

The global card search may be coordinated by the master card server, such as 3721™ server 11. The master server may coordinate the propagation of data synchronization of any updates between the slave servers. The master server may contain a global card exchange center, and all of the updates or data of the slave servers may be transmitted to the master server for passing on to another or other desired slave services for synchronization of these updates therewith. When a user conducts a search at a slave server, the search will not only performed by the local search engine of the particular slave server, but also be passed onto the master card search engine. These particular features are discussed in the co-pending application of the same assignee.

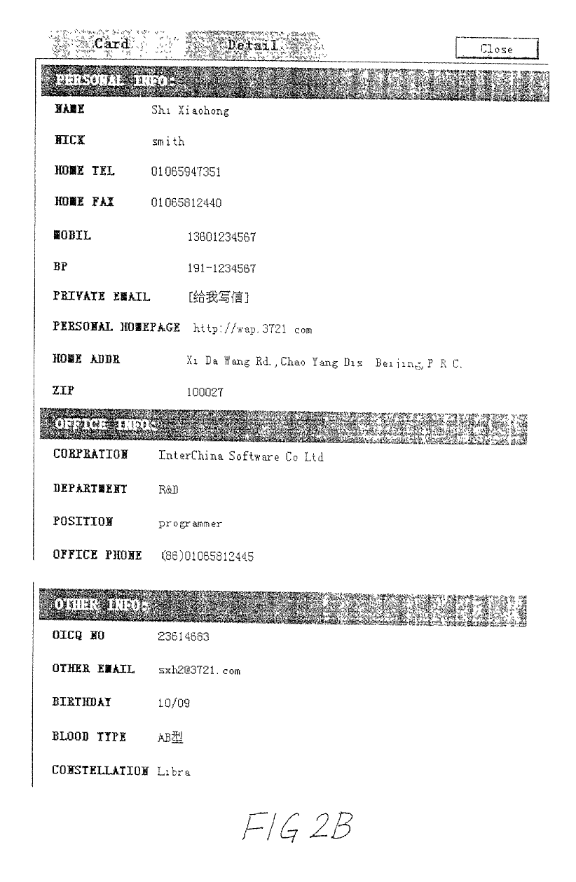

FIG. 2A shows the printout of real web card of the present invention. It can be seen that the personal information stored in the server 11 will appear in a card format 31, in analogy to a business card but much fancier. On the card, one can choose any available decoration 36, such as pet or flowers etc., a logo 37 and any background and color 38. As seen in FIG. 2B, the personal information contains a person's name, telephone number, and correspondence address (either street address or postal box). However, it may contain more information, such as name, address, website of the company where the person works, and telephone and facsimile numbers of the company, the person's cell phone number and email addresses and so on. When a searcher wants to find out a particular person, the search may reveal all of the necessary contact information.

However, none of such information is necessarily to show up on the card if the person chooses not to. Sometimes there is only a name shown up on the card to confirm the search result, while the interactive surface screen provides the searcher with options of communicating with the person being searched, who then may decide whether to contact the searcher. These options may include, but not limited to, personal message box (voice or written), public bulletin board, email box, box for exchanging cards, and even language selection. Assuming that the searcher left message or contact information to the person found through the search, he or she may then call or write back to the searcher if the person found is the right person and would like to communicate with the searcher. In any event, any personal information is sensitive and needs to be protected by all means. This aspect of privacy protection of the present invention is further disclosed in another co-pending patent application of the same assignee.

As shown in FIG. 2C, the features of the web cards of the present invention include my card folder 40, design card 46, search the net 41, and check message 44, etc. In “Design My Card” section 46, there are not just options of card appearances, but also entries of personal information and setting the level of privacy protection. As seen in FIG. 2B, the information about a person's work may include the person's name, company's name and address, the person's job title, telephone number, facsimile number, email, personal web page, mobile phone number, and pager, while the personal information may include the person's gender, age, residential address, home telephone number, etc. The most important feature is that the information entry may also contain more intimate data, such as marriage status, blood type, family physician or attorney, family history, health condition, educational status, location of past residence, date and place of birth, hobby, favorite books, movies, and even photos.

To most of people, they do not intend to disclose the aforesaid information to everybody, but almost always want to disclose such information to different groups of people. For instance, the people may be roughly classified into three groups. The first group includes social or business contacts, the second group is friends and relatives, and the third is family members. However, sometimes, one does not want anyone to know certain “intimate dada” except the ones who must know of the data. Therefore, some or most of the aforesaid “more intimate data” will not be disclosed without specific authorization of the person. Nonetheless, such data may provide a basis for a search. If someone by chance only knows or remembers a few pieces of such information, he or she may still conduct a meaningful search if the person being searched is indeed registered with a local web card system or the global web card system. The search result, however, may not necessarily display the whole lot of information to the searcher, but will at least let the searcher know whether such a person is there, for instance, identified at least by person's name being searched.

FIG. 2C also shows that the interactive screen contains my favorite card folder 42, synchronization 43, modification of web card information 47, distribution of web cards 48, and privacy control 49, card exchange record 50, and selection of background and design area 51. These features are just designed for the users convenience. This will give users more freedom of exercising control of sending and receiving the web cards, such that the personal and business card can be distributed to and synchronized with attempted recipients of the registered user's choice, and the card may be searched by any others with the limitation of the registered user's choice.

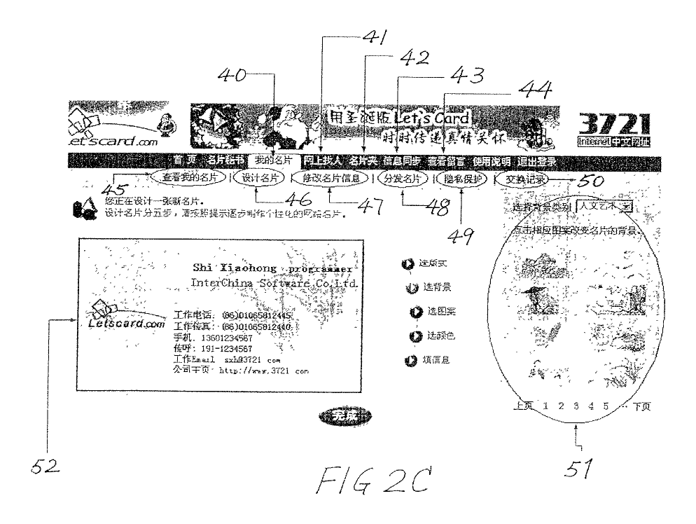

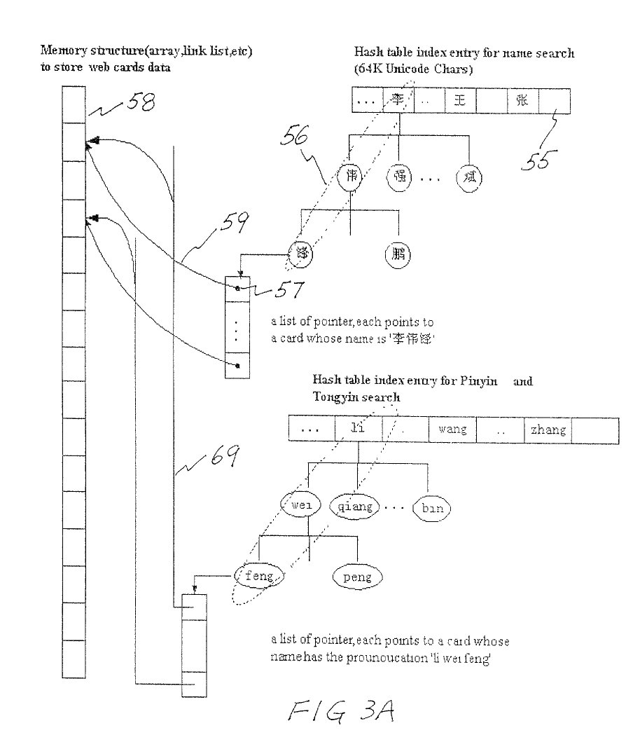

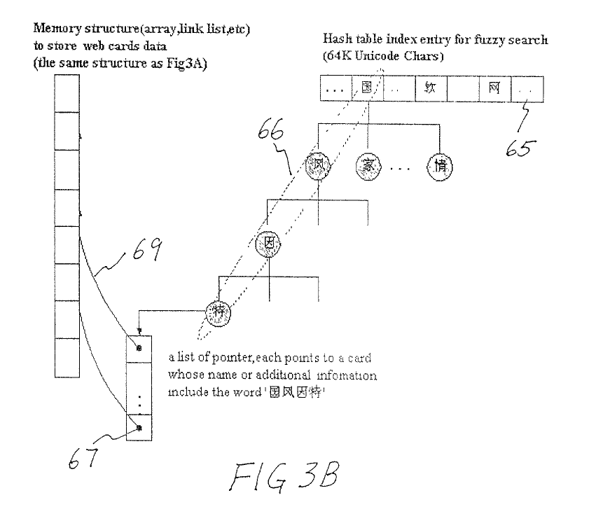

FIG. 3A illustrates the data structure adopted by the card search engine 23 to carry out the conventional search of exact or accurate matching. FIG. 3B illustrates the data structure adopted by the card search engine 23 to carry out a fuzzy or approximate search method in accordance with the present invention. The web card search engine 23 of the present invention performs both of the exact or accurate matching search as well as fuzzy or approximate search. The web card search engine 23 does not use the database of conventional relationship (RDBMS) to carry out the search. To ensure the search speed and efficiency, the specific data structure and indexing structure are established completely in the memory 58.

As seen in FIG. 3A, the key is to set up highly efficient fast indexing in addition to the establishment of the memory structure of the stored web card data therein (e.g., adoption of array and link lists, etc.). The web card search engine 23 utilizes a Hash table 55 and hierarchical structure index 56 to carry out the accurate search of name, and pin-yin (phonetic spelling) and homophony. In the search engine 23, the card data and the index data are all in the form of Unicode. Take the Hash table 55 and hierarchical index tree 56 for accurate or exact matching search as an example. The Hash table 55 is a table containing entries of all 64K characters of the Unicode. Under each entry, there is a branch of the hierarchical tree; each node 57, as shown in dot, contains a pointer 59. Each of such pointers 59 leads to a position of the actual card data stored in the memory. And the names of these cards are the same as the name constructed by all of the characters along the route from the entries of the Hash table to the nodes. Therefore, the accurate search based on names is a process of locating nodes and pointers in the hierarchical tree as illustrated in FIG. 3A. The structure of Hash table plus hierarchical index tree for pinyin or homophony search is similar to that of the search based on characters. The only difference is that the phonetic alphabetic letters, instead of characters, appear at the nodes of the hierarchical tree and the entries of the Hash table.

FIG. 3B illustrates an index structure established for carrying out the fuzzy search at the web card search engine 23. The index structure of FIG. 3B is similar to that of FIG. 3A. However, the characters form Chinese words or a phrase, as they are constructed at nodes 57 from the Hash table 55 to the hierarchical tree 56. Each node 57 contains a card pointer 59. Each pointer 59 leads to the name of the name card or other additional information containing such a word. FIG. 3B is in fact a reversed index based on searching words.

The index structure in FIGS. 3A and 3B are dynamically maintained. That is to say when the user applies for or modifies a web card, the information of this web card will be transmitted to the web card search engine, including the additional searchable information of all characteristics of the card. The search engine 23 will add such information to the two branches of the hierarchical index tree in FIG. 3A in accordance with the name of the card and its Chinese phonetic spelling. At the same time, the additional information and the name of the card will be divided into several words, and these divided words are added into the index pointers 59 corresponding to the nodes 57 of the index tree in FIG. 3B.

At present, almost all of the countries have their specified sets of characters, for instance, the specified set of Chinese characters GB2312. These sets of characters may have correspondence with the set of characters of Unicode. Therefore, the web card search engine uses Unicode characters as the encoding format to store the web card data, such that the search mode of the web card search engine of the present invention may be adopted easily for other languages, such as Japanese and Korean, etc.

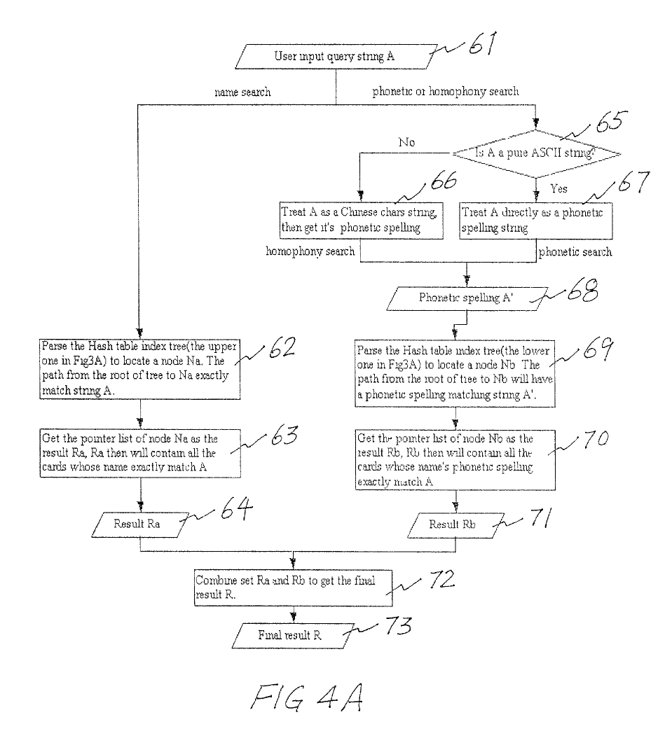

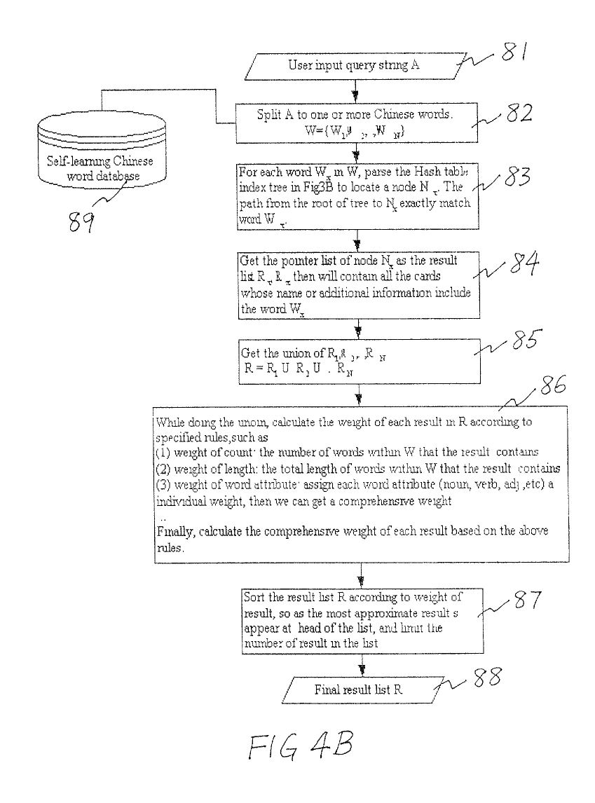

For the detailed description of the web card search of the present invention, FIG. 4A illustrates the flowchart of the search process using the accurate or exact matching search. Under the accurate or exact matching search, the search for a name is carried out by inputting 61 inquiry string A, treating the character stream A of the inquiry as the exact matching words for the name. Based on the first character of the character stream A, it will be easy to locate an entry in the Hash table 55 of FIG. 3A. Then, the following process is to find 62 a node Na within the hierarchical tree connected to this entry, to have the character corresponding to Na being equal to the last character of the character stream A of the inquiry. When the characters from the Hash table entry to the node Na are combined together, they should form the characters stream A of the inquiry. This is a traditional computing method, and its time complexity is O(N), wherein N is the length of the character stream of the inquiry. When the node Na is found, the content directed by the index pointer 63 contained in the node Na will be the desired web cards Ra with all cards matching the inquiry. If such a node is not found, it means that all of the web cards as stored in the memory 58 do not have anything matching the character stream A of the inquiry.

For the same accurate search mode, but based on phonetic spelling or homophony search, it will be substantially the same with such search for characters of the web card as described above. First, it will determine 65 whether the entered inquiry A is a pure stream of ASCII characters. If yes, treat the inquiry A as the pin-ying string 67. Then, the pin-ying string may be divided into several phonetic units in accordance with the Chinese phonetic spelling rules. Such phonetic units constitute a stream of phonetic spelling A′ 68. If the inquiry A contains not only the phonetic spelling alphabetic letters, but also Chinese characters as seen in the step 66, the Chinese characters can be converted into equivalent phonetic units through the conversion table stored in the memory 58. Thus, the stream A′ 68 of phonetic spelling can be obtained easily from the stream A of the initial inquiry. Then, the pertinent nodes Nb may be found 69 for the stream A′ through the index structure as shown in FIG. 3A. Subsequently, the pointer may be found to indicate the result Rb at the step 70 and 71. This process is the same as the process for searching the characters, i.e., the accurate or exact matching search. When combining the results Ra and Rb at the step 72, the final result R may be obtained at the step of 73.

FIG. 4B is the flowchart of the fuzzy or approximate search in accordance with the present invention. As shown in FIG. 3B, the index structure of the fuzzy or approximate search is the same as the structure of the accurate or exact matching search. For an inquiry character stream A inputted at the step 81, such as “I would like to find XYZ who works in Beijing for an IT company” in Chinese “ [symbol] IT [symbol] XYZ” the search engine 23 will break down, at the step 82 the inquiry into several words through a dictionary having self-study ability. Such words constitute a collection W. At the step 83, each word Wx is being dealt with in accordance with the way of computing same as the one for the accurate or exact matching search so as to locate a node Nx among the index structure of FIG. 3B. From each node Nx, a result collection Rx is generated at the step 84. The result collection Rx contains the web cards that have the name or additional information including the word Wx. All of the result collections Rx are consolidated to constitute a big result collection R at the step 85. During the consolidation, the similarity of each card may be evaluated by weight at the step 86. Such similarity may follow certain specific rules. Finally, all of web cards in the big result collection R are sorted out at the step 87 and arranged in accordance with the similarity, and the number of selected search results of web cards is restricted under certain rules so as to obtain the final search result collection R of the fuzzy or approximate search at the step 88.

To most of people, they do not intend to disclose all of the aforesaid information to everyone or to the general public, but may want selectively to disclose such information to certain groups of people. In any event, some of personal information are sensitive and need to be protected by all means. Therefore, a privacy control and protection is adopted in the present invention to ensure that the private and intimate data, such as the person's gender, age, marriage status, blood type, family physician or attorney, family history, health condition, educational status, location of past residence, date and place of birth, hobby, favorite books, movies, and even photos will not be published or posted unless there is specific authorization of the person being searched.

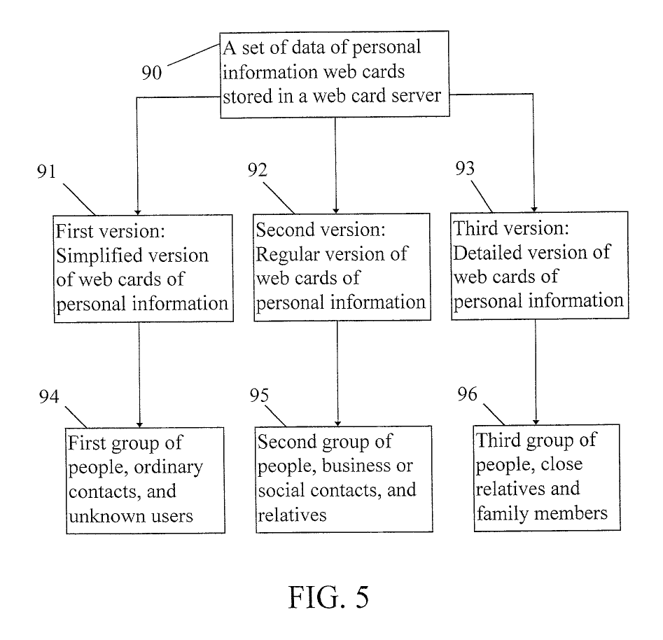

As shown in FIG. 5, the set 90 of web card information of a particular person is stored in the database 22. The information in the data set 90 may be selected to compose, respectively, into three versions of web cards. These versions of web cards are simplified version 91, regular version 92, and detailed version 93. Thus, when someone only knows or remembers a few pieces of such information, he or she may still conduct a search of the particular person who signs up the web card service and has recorded contact information at such a web card system. If the searcher is one who has never contact the particular registered person before or has given limited authorization by the registered person before. Such a searcher is classified in the first group 94 of people, i.e., public contacts. The result may not display a whole lot of information, but only the first simplified version of web card. It will display just enough information to let the searcher know whether such a person being searched is there, at least by name or a specific indicator.

However, for the second group 95 of people, i.e., social contacts and working contacts, the second version 92 of web cards is displayed provided that anyone of such contacts conducts a search of this particular registered person. Likewise, the third version 94 of web cards is designed for the third group 96 of people who are either family members or very close friends. However, except those who do not have any previous contact or, for a long time, have not contacted with the registered person, the three groups of people are indeed authorized by the registered user when the personal information is entered into the database. Such authorization can be changed from time to time. All of these are carried out by the privacy control system of the present invention.

To fulfill the aforesaid privacy control and protection, the personal and business information web card system includes memory units in the database 22 for storing sets of the personal information web cards, a privacy control memory unit containing a table of corresponding authorization passwords or security codes in association with a list of persons' names having or not having such authorization. The security codes are used to prevent any unwanted persons from getting any personal information. A privacy control unit is normally in connection with the search engine 23 to look through the authorization table, and to determine the levels of the privacy control. The privacy control unit also has a portion to transmit selected web card versions of person information to selected groups of people. Upon the issuance of a search result, the web card server 21 generates a corresponding web card to the searcher.

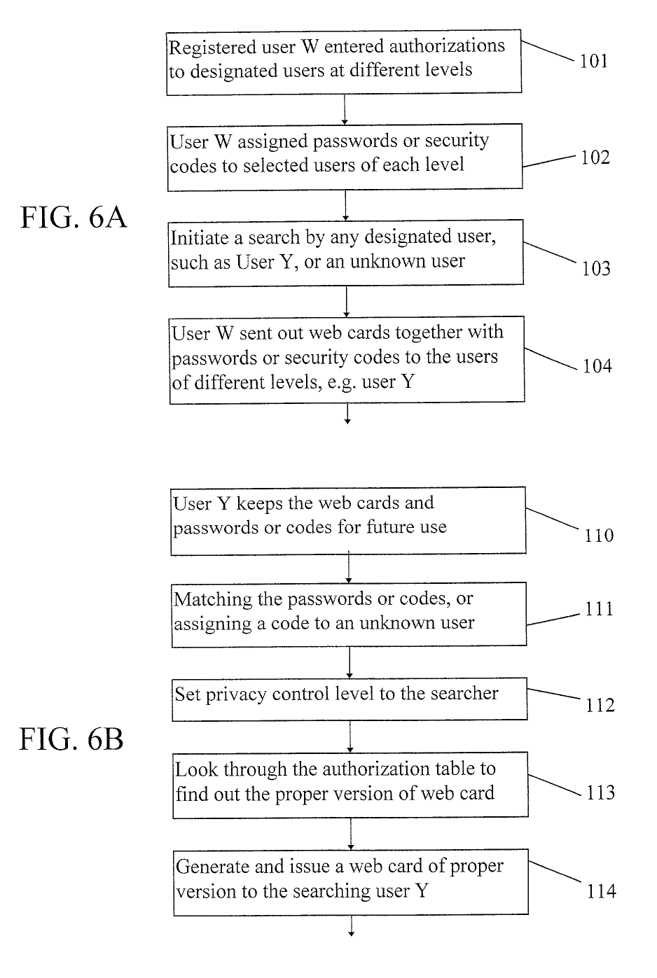

With respect to the flow chart of FIG. 6A, the registered user X has entered, at step 101, all authorizations to possible users or searchers of the personal information web card system, and assigned authorization passwords or security codes to each levels of privacy control at step 102. Then, the registered user X send out or the web card system sends out for the registered user X to selected or designated groups of people, at step 103, such as the user Y, the corresponding contact information along with the passwords or codes. The user Y may then keeps the contact information at his or her own data apparatus or organizers together with the authorization password or code.

With respect to the flow chart of FIG. 6B, the search is carried out with assigned security code or an authorization password. When a person first conducts a search of the registered user, at step 110, the search engine 23 will determine the status of the searcher and the web card system automatically gives a security code to that person. This rule is applied to any of persons who have not been listed in the authorization table, and thus such a person is treated as the first contacting person. If the person is given a limited access to the personal information, he or she may only enter the security code and the system assigns the security code to the searcher at step 111.

Otherwise, the searcher will enter an authorization password such that the system will receive such an authorization code at step 112 to determine whether the authorization is anyone of the privacy control levels. At step 113, the privacy control unit will look through the authorization table based on the entered authorization password or code to verify the code. Once the authorization is verified, the web card system will generate, at step 114, a corresponding version of information web card to the searcher.

It can be understood that the privacy control may include a fourth level of emergency version web card, designated respectively to family doctors, insurance agents, and family lawyers, etc. This will assure that the most intimate information will be available to those who are concerned.

The scope of protection of the present invention is set out in the following claims. However, any obvious modification without excess of the essence of the present invention should also be within the scope of the present invention.

What I claim is:

1. In a personal and business information web card system including at least a server having at least a database and a search engine, a privacy control system comprising:
a) means for storing a set of web card information of each individual user of the web card system;
b) means for determining privacy control levels of the web card information of the individual user as selected by the individual user;
c) means for transmitting, at the registration user's initiation, selected web card information of a particular privacy control level with an authorization code to other users;
d) means for storing a table of authorized names of the other users for each level of privacy control;
e) means for looking through the table of authorized users' names when any of the other users conducts a search; and
f) means for generating a corresponding web card of the individual user to the other user once the authorization is confirmed.

2. A privacy control system of claim 1, wherein said means for storing the web card information is part of said database.

3. A privacy control system of claim 1, wherein said means for storing a table of authorized names is part of said database.

4. A privacy control system of claim 1, wherein said means for determining privacy control levels and means for looking through the table of authorized users' names form portions of a privacy control unit.

5. A privacy control system of claim 1, wherein said means for transmitting selected web card information and means for generating a corresponding web card are part of said search engine.

6. A method of controlling privacy in a personal web card system including at least a web card server having at least a database and a search engine, comprising the steps of:
a) storing a set of web card information of each individual user of the web card system in said database;
b) determining privacy control levels of the web card information of the individual user as selected by the individual user;
c) transmitting, at registered user's initiation, selected web card information of a particular privacy control level with an authorization code to other users;
d) storing a table of authorized names of the other users for each level of privacy control;
e) looking through the table of authorized users' names when any of other users conducts a search; and
f) generating a corresponding web card of the individual user to the other user once the authorization is confirmed.

7. A method of controlling privacy of claim 6, wherein said search server includes a privacy control unit, that determines the status of a searcher who submits a search inquiry, and automatically gives the searcher a security code if the searcher is determined as a first time searching a predetermined registered user.

8. A method of controlling privacy of claim 7, wherein said privacy control unit will looks through the table of authorized users' names to decide which level of privacy control is given to the searcher, and then the server will generate a corresponding web card to the searcher.

9. A method of controlling privacy of claim 6, wherein there are at least three versions of web cards corresponding to at least three levels of privacy control of issuance of the web cards.

10. A method of controlling privacy of claim 7, wherein the three version cards are a simplified version card for unknown searchers or searchers given limited authorization, and a regular version card for regular social and working contacts, and a detailed version card for family and close friends.

11. A method of controlling privacy of claim 7, wherein there is a fourth version web card for emergency information including at least health, medical, insurance, and legal matters.

12. A method of controlling privacy of claim 6, wherein the web card system will transmit from time to time all personal information to other selected and designated users of such information, respectively, in accordance with the authorization given to these users.
